(19) United States
(12) Patent Application Publication
(10) Pub. No.: US 2004/0217621 A1
(43) Pub. Date: Nov. 4, 2004

(54) Sun visor with flexible arm

(76) Inventor: Thomas Paul McCoy, Camarillo, CA (US)

Correspondence Address: Thomas Paul McCoy, 2269 Gorman St., Camarillo, CA, 93010, US

(21) Appl. No.: 10/425,753

(22) Filed: Apr. 29, 2003

(51) Int. Cl. B60J 3/02

(52) U.S. Cl. 296/97.6

(57) ABSTRACT

A sun visor with flexible arm for shielding sun, glare, vehicle headlights or other distractions from the eyes of the vehicle's operator. The compact sun visor's shield is attached to a flexible arm, allowing for limitless visor positioning. The visor may be permanently mounted or affixed with various clips or adhesives to a motor vehicle, helmet or any object requiring shading, allowing for mounting wherever the operator desires.

### BACKGROUND OF THE INVENTION

1. Field of the Invention

This invention relates to the field of vehicle accessories. More particularly, the present invention relates to sun visors to assist in shielding sun, glare, headlights or other distractions from the eyes.

2. Description of Prior Art

The typical sun visor assembly (hereinafter visor) is permanently mounted to a limited movement arm, which is in turn permanently attached to the interior roof of a motor vehicle. The visor is capable of being pivoted about the arm between a limited “storage position” parallel to the roof of the vehicle and a position where the visor may shield unwanted light. In this “shielding” position, the visor visually blocks a large portion of the operator's view.

To allow for more satisfactory shading, other visor designs have increased the size of the visor or incorporated attachments to block larger portions of the operator's view. These attachments and/or visors block more of the operator's view than may be satisfactory and safe, such as blocking views of on-coming traffic or signal lights. These visors and/or attachments are also limited in positioning, ease of use while operating a motor vehicle, customization, and mounting locations.

In view of the foregoing limitations and shortcomings, as well as other disadvantages not specifically mentioned above, there exists a need for an improved method of shading. It is therefore a primary object of this invention to fulfill that need by providing an adjustable visor, working independently or in cooperation with existing visors, which may be mounted and positioned anywhere shade is needed.

It is also an objective of this invention to provide freedom from the foregoing limitations by blocking only the portion of a person's view that is desired and leaving the rest of the visual field open for safety and/or pleasure reasons.

It is also an objective of this invention to allow the user freedom to remove and re-install the visor whenever desired. The modular design of the visor also provides for the interchanging of a variety of shapes, textures, materials and colors to allow customization to the user's preference.

### SUMMARY OF THE INVENTION

Briefly described, these and other objectives are accomplished in the present invention by providing an infinitely flexible arm which may be bent freely in X, Y and Z space to position the visor body wherever the user desires or requires shade. This flexible shaft is also thin, providing more of a view of the road by not blocking areas that do not need to be shaded. The assembly is capable of being fastened to an existing visor, rear-view mirror, windshield or any object using a variety of interchangeable modules such as clamps, suction cups or more permanent options such as glue or screws. Said modules may be manufactured in a variety of shapes, textures, materials and colors to allow customization to the user's preference.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is a frontal view of the sun visor assembly showing my new design;

FIG. 2 is a silhouette side view of the visor assembly;

FIGS. 3, 4, and 5 illustrate the flexibility of the arm/shaft, mounting locations and use of the sun visor in a typical motor vehicle interior;

FIG. 6 illustrates how the visor assembly may be disassembled, and what options may exist in (1) custom bodies, (2) flexible arms/shafts, and (3) fastening modules; and

FIG. 7 illustrates how the visor may be used in non-motor vehicle situations where the shading of sunlight is desired.

### DETAILED DESCRIPTION OF THE PREFERRED EMBODIMENT

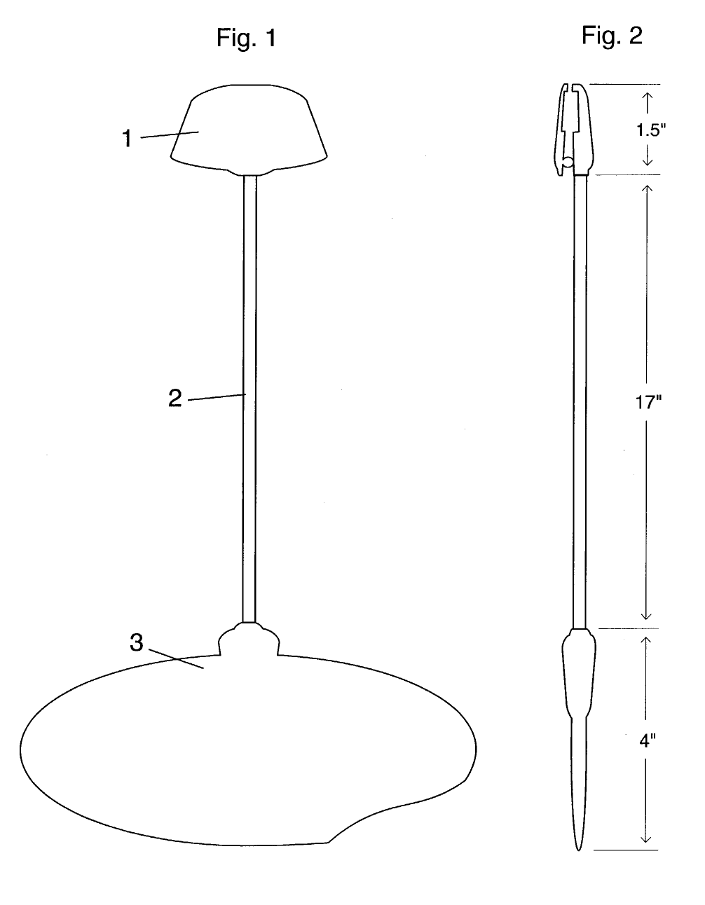

Referring now in detail to the drawings, a visor assembly embodying the principles of the present invention is shown in FIG. 1. The (1) visor body may be formed of a variety of materials, such as but not limited to: injection-molded plastic, metal, or wood. The body is attached to a (2) flexible arm/shaft by simply inserting and pressing by hand an end of the arm into the slot in the visor body. The flexible arm/shaft may be formed of a variety of materials, such as but not limited to rubber coated copper wire. The (3) clamp/fastening module is attached in the same manner as the body, where the arm/shaft is simply pressed into a slot in the module by hand.

This hand-pressing method allows for the user to assemble/disassemble the visor and interchange parts to customize it to preference. Other attachment modules may be interchanged to allow for, but not limited to, clamp, suction cup, hook and loop, or bolt-on attachments.

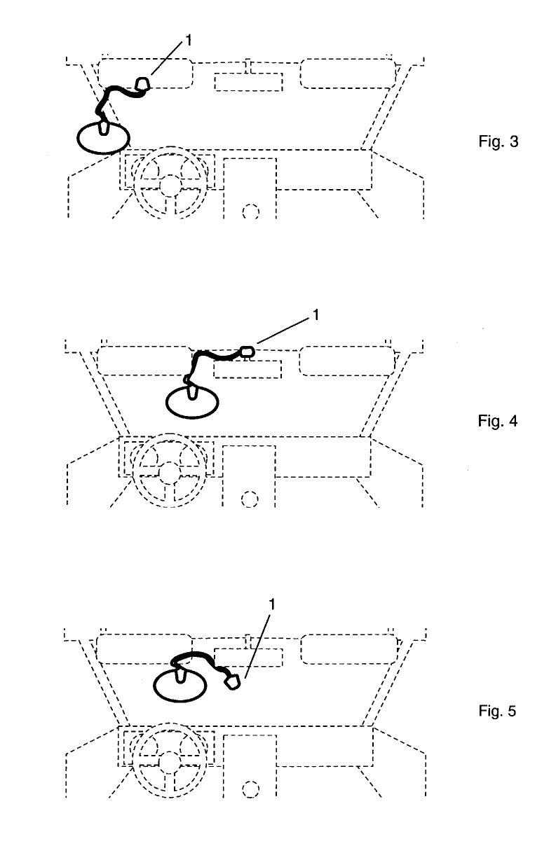

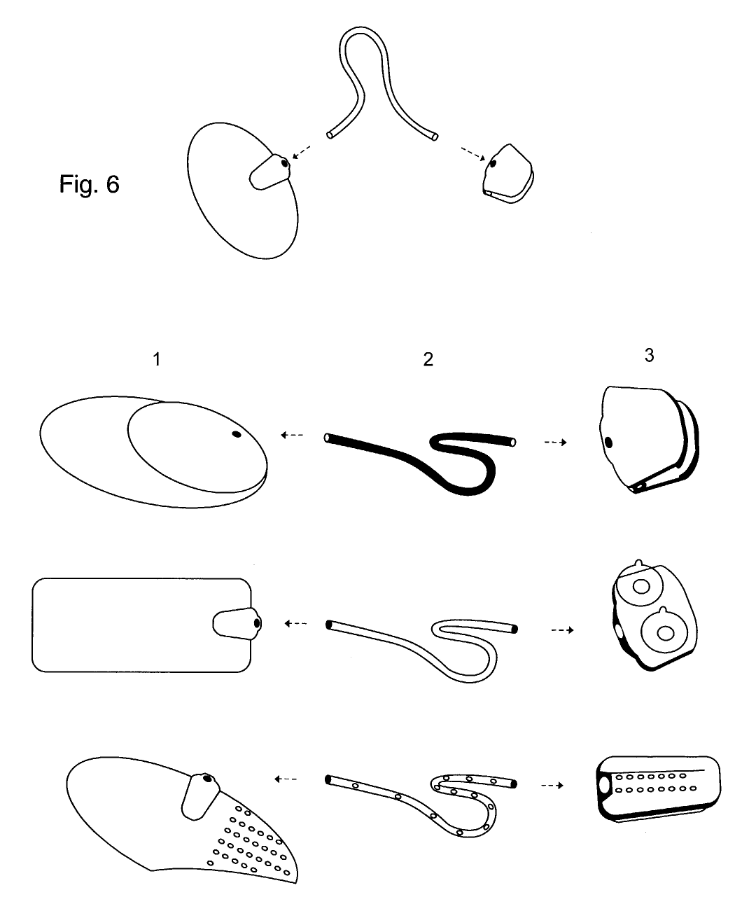

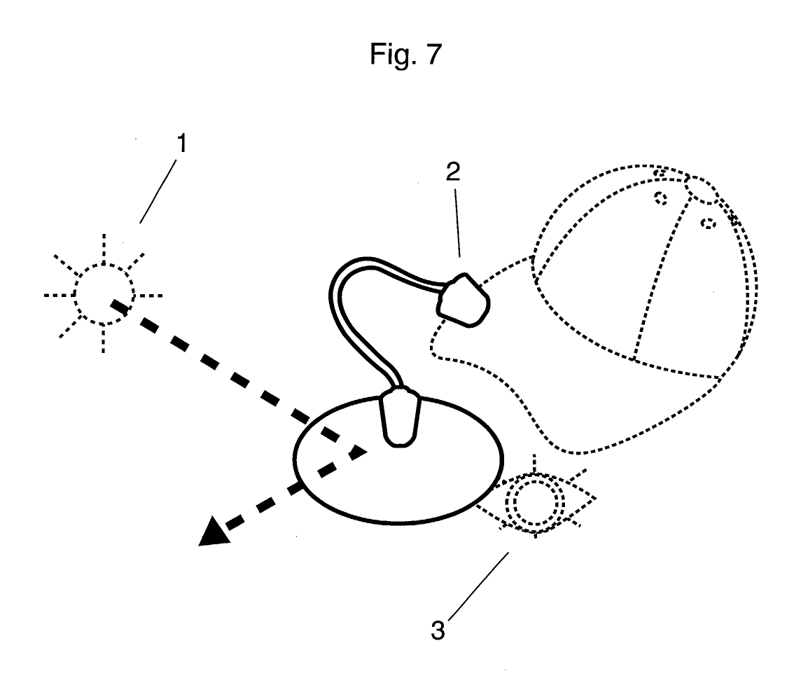

FIGS. 3, 4, 5 and 7 illustrate how the visor's flexible arm may be bent almost infinitely, and the different mounting locations permitted by the interchangeable fastening modules.

I claim:

1. A sun visor assembly, said assembly comprising:
A thin, small wafer-like visor body;
A long, flexible arm to which the visor body is attached to, allowing for countless positioning options in X, Y and Z space;
A retaining component providing a means for fastening said assembly to motor vehicle, helmet or anywhere shade is desired.

2. A sun visor assembly as set forth in claim 1, said assembly's visor, flexible arm or retaining component may be interchanged with identical components manufactured in variety of materials, shapes, textures and colors to allow the user to customize the assembly.

3. A sun visor assembly as set forth in claim 1, said assembly's retaining component may be interchanged with various temporary fasteners such as clamp, hook and loop, suction cup or permanent fasteners.
